(19) United States
(12) Patent Application Publication
(10) Pub. No.: US 2015/0215391 A1
(43) Pub. Date: Jul. 30, 2015

(54) COMMUNICATION SYSTEM AND COMMUNICATION METHOD THEREOF

(71) Applicant: Beijing Neqin Technology Co., Ltd., Beijing (CN)

(72) Inventors: Ping Cheng, Beijing (CN); Wei Wang, Beijing (CN); Jia Yu, Beijing (CN)

(21) Appl. No.: 14/420,568

(22) PCT Filed: Mar. 15, 2013
(86) PCT No.: PCT/CN2013/072717

§ 371 Date: Feb. 9, 2015

(30) Foreign Application Priority Data
Aug. 24, 2012 (CN) 201210305361.8

(51) Int. Cl. H04L 29/08; H04L 29/06

(52) U.S. Cl. CPC H04L 67/104; H04L 67/02; H04L 63/0428

(57) ABSTRACT

The invention provides a communication system comprising a local device, a peer device and a server, wherein the server comprises a conversion module for converting a message to be transmitted by the local device into a message code and storing the correspondence between the message and the message code; the local device comprises a transmission module for transmitting the message code to the peer device; and the peer device comprises an acquiring module for acquiring from the server the message corresponding to the message code. The communication system provided by the invention improves the security of the instant communication by delivering a message by means of transmitting a message code and thus reducing the possibility of message leakage.

### TECHNICAL FIELD

The invention relates to the field of data communication, and particularly to a communication system and a communication method thereof.

### BACKGROUND

Nowadays more and more people begin to use instant communication (IM) software. With the development of communication techniques, tools supporting instant communication are not limited to desktop computers any more. Devices such as mobile phones and tablet computers ad etc. have become the dominant tools for using the instant communication software. However, security of messages in a communication has become a considerable issue faced by existing instant communication software and leakage of messages will cause a tremendous security threat.

### SUMMARY

Therefore, it is an object of the invention to provide a communication system and a communication method thereof to enable a communication device to deliver a message by transmitting a message code, instead of directly transmitting contents of the message itself, so as to guarantee no leakage of the message, as well as the security of the instant communication software.

In order to achieve the above object, the invention provides a communication system comprising a local device, a peer device and a server, wherein
the server comprises a conversion module for converting a message to be transmitted by the local device into a message code and storing the correspondence between the message and the message code;
the local device comprises a transmission module for transmitting the message code to the peer device; and
the peer device comprises an acquiring module for acquiring from the server the message corresponding to the message code.

According to the above system, the conversion module is further configured to set a valid period for the correspondence between the message and the message code, wherein the correspondence between the message and the message code will be deleted if the valid period is expired.

According to the above system, the conversion module is further configured to delete the correspondence between the message and the message code after the peer device acquires from the server the message corresponding to the message code.

According to the above system, the message to be transmitted is an encrypted message, wherein the local device further comprises an encryption module for encrypting the original message to be transmitted and the peer device further comprises a decryption module for decrypting the acquired message.

According to the above system, the local device further comprises an encryption module for encrypting the message code before the message code is transmitted to the peer device, and the peer device further comprises a decryption module for decrypting the encrypted message code before the message corresponding to the message code is acquired from the server.

In order to achieve the above object better, the invention also provides a communication method for a communication system comprising a local device, a peer device and a server, the method comprising:
a converting step for the server converting a message to be transmitted by the local device into a message code and storing the correspondence between the message and the message code;
a transmission step for the local device transmitting the message code to the peer device; and
an acquiring step for the peer device acquiring from the server the message corresponding to the message code.

According to the above method, in the converting step, the server sets a valid period for the correspondence between the message and the message code, wherein the correspondence between the message and the message code will be deleted if the valid period is expired.

According to the above method, after, in the acquiring step, the peer device acquires from the server the message corresponding to the message code, the server deletes the correspondence between the message and the message code.

According to the above method, the message to be transmitted is an encrypted message, wherein the method further comprises an encrypting step before the converting step for the local device encrypting the original message to be sent, and a decrypting step after the acquiring step for the peer device decrypting the acquired message.

According to the above method, the transmission step further comprises the local device encrypting the message code before transmitting the message code to the peer device, and the acquiring step further comprises the peer device decrypting the encrypted message code before acquiring the message corresponding to the message code from the server.

In general, the communication system and the communication method thereof provided by the invention improve the security of the instant communication by transmitting a message by means of transmitting a message code and thus reducing the possibility of message leakage.

### BRIEF DESCRIPTION OF THE DRAWINGS

In order to more clearly explain solutions of embodiments of the invention, the embodiments will be introduced below referring to the accompanying figures. The embodiments described below are only examples and other embodiments may be made according to these embodiments by one with ordinary skills in the art without any inventive effort.

FIG. 1 is a flowchart of the method according to the invention;

FIG. 2 is a flowchart of the method according to an embodiment of the invention;

FIG. 3 is a block diagram of the system according to an embodiment of the invention;

FIG. 4 is a flowchart of the method according to another embodiment of the invention; and

FIG. 5 is a block diagram of the system according to another embodiment of the invention.

### DETAILED DESCRIPTION

To make the purposes, the solutions and the advantages of embodiments of the invention more clear, the embodiments of the invention will be further explained in detail below, in connection with the figures. The illustrative embodiments of the invention and explanation thereof are used to explain the invention, rather than a limitation.

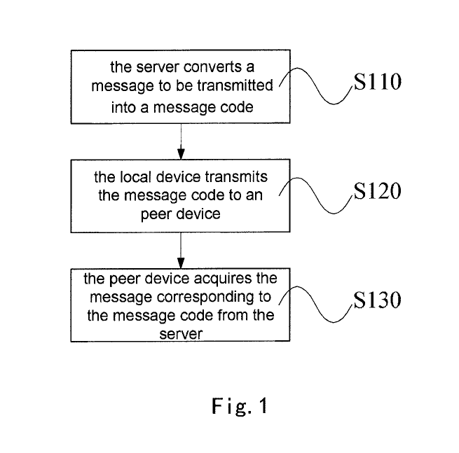

Referring to FIG. 1, the particular flow of the invention is show as:

In step S110, a server converts a message to be transmitted by a local device into a message code. This message was transmitted by the local device to the server. The server then returns the converted message code back to the local device. Meanwhile, the server stores the one-by-one correspondence between the message and the message code. As shown in Table 1, a valid period may be set for the stored correspondence. For example, the valid period may be set as 24 hours. The, the correspondence will be deleted after 24 hours. According to an embodiment of the invention, the message converted and stored in the server may be either encrypted or unencrypted.

| | Message | |
|---|---|---|
| Number | Code | Message |
| 1 | 10010001 | The psychological price of the negotiator might |
| | | be $1,300,000. Please give you instruction. |
| 2 | 20010001 | Bank card No. XXXX, Withdraw password XXXX. |
| | | Keep it a secret! |
| 3 | 30010001 | The negotiation of the contract has been completed |
| | | and a signing will be made tomorrow. |

In step S120, the local device transmits the message code to a peer device which can communicate with the local device via any network, using any communication software, etc, to which the invention will not made a limitation.

In step S130, the peer device acquires, from the server storing the correspondence between the message and the message code, the message corresponding to the message code. Furthermore, the server may be set to delete the correspondence between the message and the message code after the peer device acquires the corresponding message from the server.

It should be noted that both the local device and the peer device may be of any device capable of performing transmission and receiving operations, including but not limited to a desktop computer, a notebook computer, a tablet computer and a mobile phone. Additionally, a local device and a peer device are named with respect to each other. Every device may either be regarded as a local device when transmitting a message code, or as a peer device when receiving a message code.

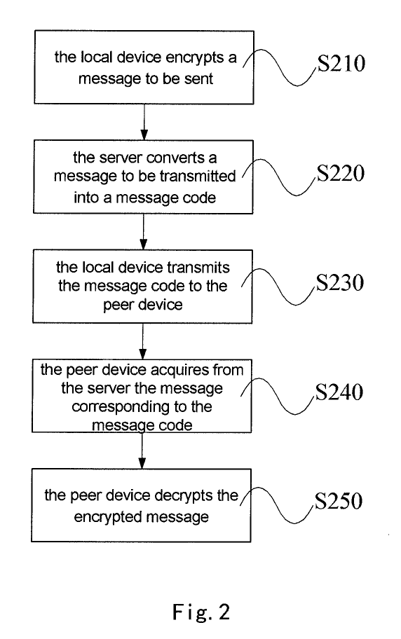

FIG. 2 is a flowchart of an embodiment of the invention, and the flow is shown as:

In step S210, the local device encrypts a message to be sent. Any existing encryption technique can be used to perform the encryption, to which no limitation will be made by the invention.

In step S220, the server converts the message to be sent by the local device into a message code and returns the message code to the local device, and stores the correspondence between the message and the message code at the same time. It should be noted that the message received, from the local device, and converted by the server is an encrypted message.

In step S230, the local device transmits the message code to the peer device.

In step S240, the peer device acquires from the server the message corresponding to the message code. It should be noted that the message acquired by the peer device is the message encrypted by the local device.

In step S250, the peer device decrypts the acquired message. Any existing decryption technique corresponding to the encryption can be used to perform the decryption, to which no limitation will be made by the invention.

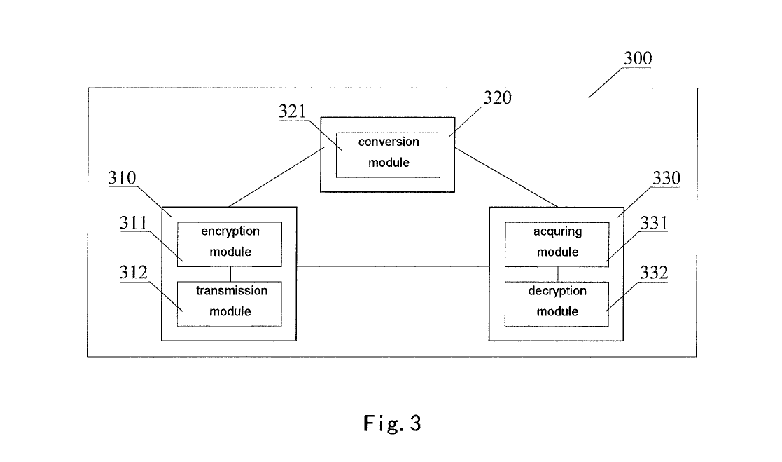

FIG. 3 is a block diagram of a system according to an embodiment of the invention, in which the communication system 300 comprises a local device 310, a server 320 and a peer device 330. The local device 310 comprises a module for communicating with the server and a transmission module 312 for transmitting the message code to the peer device 330. Optionally, the local device 310 further comprises an encryption module 311 for encrypting the message. The server 320 comprises a module for communicating with the local device 310 and the peer device 330, and a conversion module 321 for converting the message to the message code. The peer device 330 comprises a receiving module for receiving the message code and an acquiring module 331 for acquiring, from the server 320, the message corresponding to the message code. Optionally, the peer device 330 may further comprise a decryption module 332 for decrypting the encrypted message.

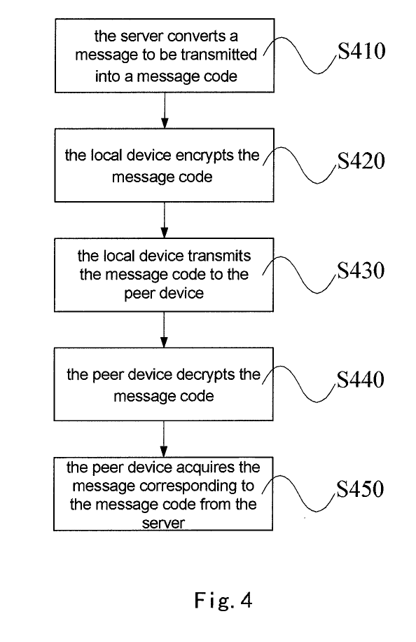

FIG. 4 is a flowchart of the method according to another embodiment of the invention, and the flow is shown as:

In step S410, the server converts a message to be transmitted by the local device into a message code and then returns the message code to the local device, and stores the correspondence between the message and the message code at the same time.

In step S420, the local device encrypts the message code. Any existing encryption technique can be used to perform the encryption, to which no limitation will be made by the invention.

In step S430, the local device transmits the message code to the peer device. It should be noted that the message code being transmitted here has been encrypted.

In step S440, the peer device decrypts the encrypted message code. Any existing decryption technique correspond to the encryption can be used to perform the decryption, to which no limitation will be made by the invention.

In step S450, the peer device acquires, from the server storing the correspondence between the message and the message code, the message corresponding to the decrypted message code.

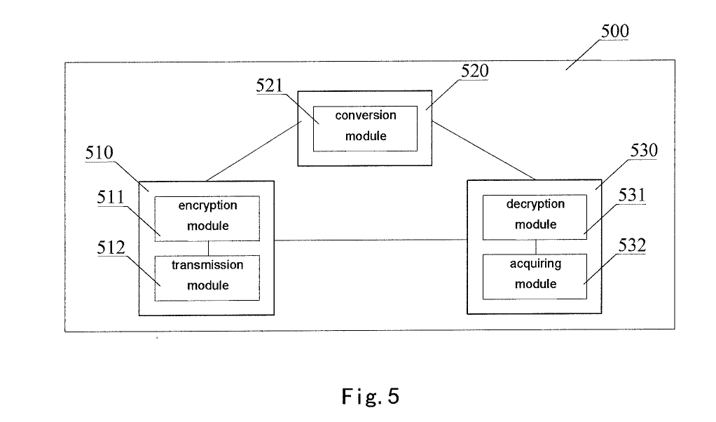

FIG. 5 is a block diagram of the system according to another embodiment of the invention, in which the communication system 500 comprises a local device 510, a server 520 and a peer device 530. The local device 510 comprises a module for communicating with the server, an encryption module 511 for encrypting the message code and a transmission module 512 for transmitting the message code. The server 520 comprises a module for communicating with the local device 510 and the peer device 530, and a conversion module 521 for converting the message to the message code. The peer device 530 comprises a receiving module for receiving the message code, a decryption module 531 for decrypting the encrypted message code and an acquiring module 532 for acquiring, from the server 520, the message corresponding to the message code.

The embodiments described above in detail further explain the purpose, the solutions and the advantages of the invention. It should be understood that what described above are only particular implementations of the invention and should not be used to limit the protection scope of the invention. Any modifications, equivalences and improvements within the spirit and principle of the invention should be contained in the protection scope of the invention.

We claim:

1. A communication system comprising a local device, a peer device and a server, wherein:
the server comprises a conversion module for converting a message to be transmitted by the local device into a message code and storing the correspondence between the message and the message code;
the local device comprises a transmission module for transmitting the message code to the peer device; and
the peer device comprises an acquiring module for acquiring from the server the message corresponding to the message code.

2. The system of claim 1, wherein the conversion module is further configured to set a valid period for the correspondence between the message and the message code, and wherein the correspondence between the message and the message code will be deleted if the valid period is expired.

3. The system of claim 1, wherein the conversion module is further configured to delete the correspondence between the message and the message code after the peer device acquires from the server the message corresponding to the message code.

4. The system of claim 1, wherein the message to be transmitted is an encrypted message, and the local device further comprises an encryption module for encrypting the original message to be sent, and the peer device further comprises a decryption module for decrypting the acquired message.

5. The system of claim 1, wherein the local device further comprises an encryption module for encrypting the message code before the message code is transmitted to the peer device, and the peer device further comprises a decryption module for decrypting the encrypted message code before the message corresponding to the message code is acquired from the server.

6. A communication method for a communication system comprising a local device, a peer device and a server, the method comprising:
a converting step for the server converting a message to be transmitted by the local device into a message code and storing the correspondence between the message and the message code;
a transmission step for the local device transmitting the message code to the peer device; and
an acquiring step for the peer device acquiring from the server the message corresponding to the message code.

7. The method of claim 6, wherein, in the converting step, the server sets a valid period for the correspondence between the message and the message code, and the correspondence between the message and the message code will be deleted if the valid period is expired.

8. The method of claim 6, wherein after, in the acquiring step, the peer device acquires from the server the message corresponding to the message code, the server deletes the correspondence between the message and the message code.

9. The method of claim 6, wherein the message to be transmitted is an encrypted message, the method further comprises: an encrypting step before the converting step for the local device encrypting the original message to be sent, and a decrypting step after the acquiring step for the peer device decrypting the acquired message.

10. The method of claim 6, wherein the transmission step further comprises the local device encrypting the message code before transmitting the message code to the peer device, and the acquiring step further comprises the peer device decrypting the encrypted message code before acquiring the message corresponding to the message code from the server.
